(19) United States
(12) Patent Application Publication
(10) Pub. No.: US 2005/0025225 A1
(43) Pub. Date: Feb. 3, 2005

(54) Method and apparatus for weighting channel coefficients in a rake receiver

(76) Inventors: Jurgen Niederholz, Kerken (DE); Burkhard Becker, Ismaning (DE); Michael Speth, Krefeld (DE); Armin Hautle, Dachau (DE); Ernst Bodenstorfer, Brunn am Gebirge (AT); Michael Hofstatter, Perchtoldsdorf (AT); Filip Netrval, Wien (AT); Guillaume Sauzon, Unterhaching (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/875,770

(22) Filed: Jun. 24, 2004

(30) Foreign Application Priority Data
Jul. 1, 2003 (DE) DE 103 29 632.8

(51) Int. Cl. H04B 7/216

(52) U.S. Cl. 375/148; 370/342; 375/346

(57) ABSTRACT

In a method for variable weighting of channel coefficients for a RAKE receiver, at least one variable that is characteristic of a transmitter and/or transmission channel and/or receiver characteristic is assessed. A correction factor is determined, which is dependent on the assessment result. The channel coefficients are multiplied by the correction factor, and the corrected channel coefficients are used as the basis for equalization in the RAKE receiver.

### REFERENCE TO RELATED APPLICATIONS

This application is related to U.S. application Ser. No. ______ (Attorney Docket No. LLP129US), filed on Jun. 24, 2004, entitled “METHOD AND APPARATUS FOR CALCULATION OF PATH WEIGHTS IN A RAKE RECEIVER”, and U.S. application Ser. No. ______ (Attorney Docket No. LLP130US), filed on Jun. 24, 2004, entitled “METHOD AND APPARATUS FOR CALCULATION OF CORRECTION FACTORS FOR PATH WEIGHTS IN A RAKE RECEIVER”, both of which are hereby incorporated by reference in their entirety.

This application claims the benefit of the priority date of German application DE 103 29 632.8, filed on Jul. 1, 2003, the contents of which are herein incorporated by reference in their entirety.

### FIELD OF THE INVENTION

The invention relates to a method and an apparatus for weighting channel coefficients that have been calculated in a channel estimator.

### BACKGROUND OF THE INVENTION

One typical receiver concept that is used in CDMA (Code Division Multiple Access) transmission systems is the so-called RAKE receiver. The method of operation of RAKE receivers is based on weighting the signal contributions that reach the receiver via different transmission paths, and adding them up in a synchronized form. For this purpose, the RAKE receiver has a number of fingers, whose outputs are connected to a combiner. During operation, the fingers are associated with the individual propagation paths, and carry out the path-specific demodulation process (delay, despreading, symbol formation, multiplication by the path weight). The combiner superimposes those signal components that have been transmitted via different propagation paths and are associated with the same signal.

A channel estimate is required for calculation of the path weights. The channel coefficients of the transmission channel are estimated for the channel estimate. These channel coefficients are then used to calculate the path weights for the RAKE equalizer. Various options are known for this:

The standard method for calculation of the path weights comprises a channel estimate being produced on the basis of a pilot channel and the complex-conjugate channel coefficients obtained in this way being used as path weights for the equalization of a signal which has been transmitted via a payload data channel. In the case of UMTS (Universal Mobile Telecommunications System), the so-called CPICH channel (Common Pilot Channel) is made available as a common pilot channel by each base station. A specific CPICH code that comprises 256 chips and is known in each mobile radio receiver, is transmitted in a continuously repeated form via the CPICH channel. The channel coefficients are determined by comparison of the received CPICH code with the known CPICH code. Payload data cannot be transmitted via the CPICH channel. In the UMTS Standard, for example, the DPCH channels (Downlink Dedicated Physical Channel) are available for payload data transmission. With the standard approach described above, the payload data signal which is intended for a specific subscriber (mobile station) and is transmitted via a DPCH channel is demodulated using the complex-conjugate channel coefficients that have been determined on the basis of the CPICH channel estimate and which are thus then used as path weights for the demodulation (equalization) of the payload data signal.

It is also known for the path weights to be calculated on the basis of the MRC principle (Maximum Ratio Combining). In this approach, the channel coefficients that are associated with the individual transmission paths are weighted with their path-specific signal-to-noise power plus interference ratio (SINR), and are then combined (added). The SINR-specific weighting of the individual path contributions before their combination results in the maximum SINR, which is characteristic of MRC, for the combined signal.

In the end, the critical factor for the performance of a receiver is the bit error rate of the data signal as reconstructed in,the receiver. The bit error rate can be influenced in a retrograde manner, as a result of sub-optimum design, by all of the processing steps in the reception signal path from the antenna of the radio-frequency section to the output of the channel decoder (if provided). In general, it is assumed that MRC allows a lower bit error rate than the standard approach described above for calculation of path weights from channel coefficients. However, this has the disadvantage that MRC requires increased computation complexity, since the SINR must be calculated for each propagation path.

### SUMMARY OF THE INVENTION

The German Patent Application No. 103 28 340.4 entitled, “Method and apparatus for calculation of path weights in a RAKE receiver”, which was filed by the same applicant of the present invention on Jun. 24, 2003, and is herein incorporated by reference in its entirety, describes the use of a normalization factor for calculation of the path weights from the channel coefficients. The normalization factor takes account of and compensates for the transmitter-end power regulation of the dedicated (subscriber-specific) payload data channel, which cannot be taken into account when the channel coefficients are determined solely on the basis of the common CPICH channel. In general, this measure also makes it possible to achieve a reduction in the bit error rate.

The invention is based on the object of specifying a method and an apparatus that, in practical use, achieve a receiver performance that is as high as possible with a low bit error rate, with as little computation complexity as possible.

The solution according to the invention is based on the idea of weighting the channel coefficients for the RAKE receiver variably. First of all, channel coefficients are estimated for a number of propagation paths of a transmission channel. A variable that is characteristic of a transmitter and/or transmission channel and/or receiver characteristic is assessed. A correction factor is then determined for at least one propagation path, as a function of the assessment result. The channel coefficient estimated for this propagation path is multiplied by the correction factor (which is dependent on the assessment result), with the equalization in the RAKE receiver being based on the channel coefficient multiplied by the correction factor.

The invention is based on the discovery that the gain of the MRC and/or in addition the gain which is achieved by taking account of the power regulation of the dedicated payload signal varies to a major extent with respect to the bit error rate to be achieved, as a function of the transmission scenario and the transmitter and/or receiver characteristics. While taking account of the path-specific SINR or noise variances (MRC principle), or else taking account of normalization factors in order to compensate for the power regulation influences on the path weights offers considerable advantages in certain conditions, the quantitative gain in other conditions (transmission scenario, transmitter and/or receiver characteristics) does not justify the additional computation complexity for the calculation of the correction factor. In poor conditions, the calculation of the correction factor may be associated with such a high estimation inaccuracy that the use of the correction factor even results in a degradation in the bit error rate in comparison to the standard approach (in which the path weights are the complex-conjugate channel coefficients). The invention provides the capability to use correction factors calculated in a different way depending on the current transmitter, transmission channel and/or receiver characteristic and, in consequence, also to use path weights calculated in a different manner for equalization, so that optimum receiver performance can always be achieved, based on actual system scales.

Thus, for scenarios in which the use of the MRC principle does not lead to significant gains (that is to say gains that are negligible on real system scales), the conventional combination principle (that is to say the standard approach) can be used with a virtually equivalent performance, but with considerably less complexity. This results in a reduction in the power consumption. Furthermore, difficult transmission scenarios in which the estimates of the correction factor or factors are highly susceptible to errors and in which the use of the MRC principle would therefore give poorer results than the use of the standard approach can be identified. It is thus also possible to use the conventional standard approach in these cases, which is then more powerful and less complex.

The reassessment of the at least one characteristic variable and the determination of a correction factor as a function of the assessment result can be carried out continuously and repeatedly during reception. This means that the receiver is continuously operated in an operating state that is optimized for performance and power consumption.

According to a first particularly preferred embodiment of the invention, the correction factor assumes either a predetermined fixed value or at least one of the following values, as a function of the assessment result: the ratio of a transmission-channel-specific gain estimate to a pilot-channel-based gain estimate, an estimated value for the noise variance of one propagation path of the transmission-channel, or the product of the ratio of a transmission channel-specific gain estimate to a pilot-channel-based gain estimate. In other words, a conventional standard combination can be carried out in a first operating mode, and either the compensation for the transmitter-end power regulation can be activated or deactivated, or the MRC can be activated or deactivated, or both of the measures mentioned above may be taken, in further operating modes. If no compensation is applied for the transmitter-end power regulation of the transmission channel, the two gain estimates are not calculated. If the MRC functionality is deactivated, the path-specific noise variances are not calculated.

One characteristic variable on which the assessment of the transmitter and/or transmission channel and/or receiver characteristic is based is, advantageously, the speed of the RAKE receiver relative to the transmitter. For speeds that are greater than a limiting speed, the transmission characteristics of the transmission channel change in a relevant manner over the duration of one code word (in UMTS, the duration of a code word is expressed by a TTI (Time Transmission Interval)). In this case, it is possible not only to compensate for the transmitter-end power regulation (by taking account of the ratio of a transmission-channel-specific gain estimate to a pilot-channel-based gain estimate in the correction factor), but also to activate the MRC (by taking into account the path-specific noise variances).

One variable that is used for the assessment of the transmitter and/or transmission channel and/or receiver characteristics advantageously indicates whether the power of the transmission channel is being regulated in the transmitter. No compensation for power regulation at the transmitter end is provided in the calculation of the path weights in the receiver unless this is the case.

A further variable on which the choice of an operating mode is preferably based is a variable which indicates whether an AWGN (additive Gaussian white noise) noise component, which is caused by adjacent cell interference, or a fading noise component, which is caused by intercell multipath interference, is dominant in the received signal. The activation of MRC is worthwhile only in the second case.

Furthermore, a variable is preferably taken into account that indicates the SINR ratio of the signal that is transmitted via the transmission channel. Both the activation of MRC and the compensation for the transmitter-end power regulation are worthwhile, for example, only if the SINR is sufficiently high.

Furthermore, other influencing variables, such as information about the channel profile, can also be gainfully taken into account in the selection of the operating mode.

### BRIEF DESCRIPTION OF THE DRAWINGS

The invention will be explained in more detail in the following text using an exemplary embodiment and with reference to the drawings, in which:

FIG. 1 shows the data structure of the DPCH (Downlink Dedicated Physical Channel) in the UMTS Standard;

FIG. 2 shows a schematic illustration to explain the influence of transmitter-end signal processing and of the transmission channel on signal vectors (which are received in the receiver) of the common pilot channel (CPICH channel) and of the payload data signal (DPCH channel);

FIG. 3 shows an outline illustration of a RAKE receiver with a unit according to the invention for calculation of correction factors as a function of the operating mode, for determination of path weights;

FIG. 4 shows a diagram in which the block error rate for a first transmission scenario is plotted for two different operating modes against the ratio of the mean transmission energy per chip in the DPCH channel to the spectral overall transmission power density Ec/Ior; and

FIG. 5 shows a diagram in which the block error rate for a second transmission scenario is plotted for two different operating modes against the ratio of the mean transmission energy per chip in the DPCH channel to the spectral overall transmission power density Ec/Ior.

### DETAILED DESCRIPTION OF THE INVENTION

The method according to the invention will be explained in the following text with reference to an example, to be precise the calculation of path weights for the DPCH channel. The example is based on a RAKE receiver that is compliant with the UMTS requirements. The method according to the invention may, however, also be used for calculation of path weights for other data channels and in mobile radio systems of a general type in the third and higher generations.

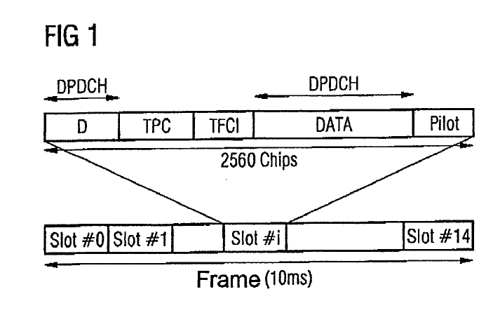

In order to understand the invention better, FIG. 1 shows the frame and time slot (slot) structure of the DPCH channel. The frame duration is 10 ms, and comprises 15 time slots slot #0 to slot #14. The fields D, TPC, TFCI, DATA, Pilot are transmitted in each time slot. The fields D and DATA contain payload data in the form of spread-coded data symbols. These two data fields form the so-called DPDCH channel (Dedicated Physical Data Channel). The TPC (Transmission Power Control) field is used for power regulation. The TFCI (Transport Format Combination Indicator) field is used to signal to the receiver the transport formats for the transport channels on which the transmitted frame will be based. The Pilot field contains between 4 and 32 (dedicated) pilot chips. Overall, one time slot comprises 2560 chips. The chip time duration (which is specified as fixed in the UMTS Standard) is 0.26 μs.

The following text is based on multipath propagation in the downlink (downlink path from the base station to the mobile station) via M propagation paths. It is assumed that synchronized reception, including the processing steps of despreading, descrambling and integration over one symbol duration, has already been carried out. The steps of despreading and descrambling are provided by multiplication operations by code sequences whose energy is normalized at the chip level and—in accordance with the normal method of operation of a RAKE receiver—are carried out for the associated propagation path in each RAKE finger. The subsequent integration over the symbol time duration is frequently also referred to as integrate and dump, and adds up the synchronized, despread and descrambled chips in a symbol. The number of chips to be added up is predetermined in a known manner by the spreading factor SF of the respective channel whose path component is demodulated in the finger under consideration. In the signal path downstream of the integrator, the data is at the symbol clock rate. The symbol sequences received in this way can be represented as vectors x_{C}(k) for the P-CPICH channel (the CPICH channel is composed of the so-called primary CPICH channel, P-CPICH, and the secondary CPICH channel, S-CPICH), and x_{D}(k) for the DPCH channel, with each vector component being associated with a symbol sequence which has been transmitted via one of the m=1, . . . , M propagation paths:

$$\begin{matrix}{x}_{C} ( k ) = [ \begin{matrix}{x}_{C ; 1} ( k ) \\ ⋮ \\ {x}_{C ; m} ( k ) \\ ⋮ \\ {x}_{C ; M} ( k )\end{matrix} ] , & ( 1 ) \\ {x}_{D} ( k ) = [ \begin{matrix}{x}_{D ; 1} ( k ) \\ ⋮ \\ {x}_{D ; m} ( k ) \\ ⋮ \\ {x}_{D ; M} ( k )\end{matrix} ] & ( 2 )\end{matrix}$$

The individual vector components for the P-CPICH channel and for the DPCH channel are given by:
x_{C;m}(k)=W_{C}a_{C;m}(k)p_{C}(k)+n_{C;m}(k), (3)
x_{D;m}(k)=Wₓa_{D;m}(k)sₓ(k)+n_{D;m}(k), (4)
with the channel-specific real gains:
W_{C}=W_{C,offset}W_{C,SF}, (5)

$${W}_{x} = {W}_{x , offset} {W}_{PC} {W}_{D , SF} where {W}_{x , offset} = \{ \begin{matrix}{W}_{D , offset} \\ {W}_{TPC , offset} \\ {W}_{TFCI , offset} \\ {W}_{DATA , offset}\end{matrix} , \qquad ( 6 )$$

the path-specific complex channel coefficients a_{C;m}(k), a_{D;m}(k) , the noise contributions n_{C;m}(k), n_{D;m}(k), the energy-normalized pilot sequence p_{C}(k) as well as the energy-normalized data symbol, TPC, TFCI and data symbol sequences sₓ(k)=p_{D}(k), s_{TPC}(k), s_{TFCI}(k), s_{DATA}(k). The weights W_{C,offset}, W_{X,offset} take account of the transmitter-end gain in the P-CPICH channel, and the fields X in the DPCH channel, and the weights W_{C,SF}, W_{D,SF}, take account of the respective spreading factor in the P-CPICH channel and the DPCH channel. The weight W_{PC} takes account of the power regulation in the DPCH channel. W_{C} and W_{X} are constant over one UMTS slot. W_{PC} can assume different values in each time slot, as a result of the power regulation.

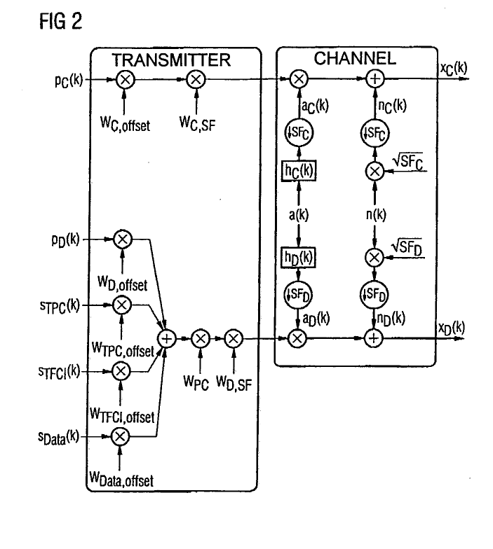

FIG. 2 illustrates the composition of the complex vectors x_{C}(k) and X_{DSCH}(k). The generation process in the transmitter comprises weighting of the respective symbol sequences corresponding to equations (3) and (5), as well as (4) and (8), respectively. The illustration is based on the assumption that the initial sequence p_{C}(k) and the initial sequences P_{D}(k), s_{TPC}(k), s_{TFCI}(k) and s_{Data}(k) are all normalized with respect to the chip energy E_{Chip}=1. The power setting values W_{C,offset} and W_{X,offset}, X=D, TPC, TFCI, DATA may differ, but are regarded as being constant over time in the following text. The factors W_{C,SF} and W_{D,SF} which define the spreading gain are determined by the spreading factor SF_{C} of the P-CPICH channel and the spreading factor SF_{D} of the DPCH channel, that is to say W_{C,SF}=SF_{C} and W_{D,SF}=S_{FD}. As already mentioned, the factor W_{PC} takes account of the power regulation mechanism, which is carried out only for the DPCH channel.

It should be mentioned that there is no a-priori information about the ratio of the power setting values W_{C,offset} to W_{X,offset}.

The influence of the channel is indicated by the channel impulse response a(k) and the noise contribution n(k). It should be mentioned that these two variables describe the channel behaviour on a chip time basis, indexed (likewise) by the index k. The respective spreading factors SF_{C} and SF_{D} are taken into account by each vector component (that is to say each propagation path) being filtered using the channel impulse response a(k), and being undersampled on the basis of the respective spreading factor. The corresponding filters h_{C}(k) and h_{D}(k) have the form:

$${h}_{C} ( k ) = \{ \begin{matrix}1 / {SF}_{C} & k ∈ [ 0 , {SF}_{C} - 1 ] \\ 0 & else\end{matrix} , \\ {h}_{D} ( k ) = \{ \begin{matrix}1 / {SF}_{D} & k ∈ [ 0 , {SF}_{D} - 1 ] \\ 0 & else\end{matrix} .$$

The vectors of the noise contributions n_{C}(k) and n_{D}(k), which are defined on a symbol time basis, are obtained from the channel noise n(k) by multiplication by SF_{C}^{1/2} and SF_{D}^{1/2}, respectively, and are likewise undersampled by the corresponding spreading factors. The vectors of the noise contributions n_{C}(k) and n_{D}(k), respectively, are additively included in the vectors x_{C}(k) and x_{D}(k), respectively.

The calculation of path weights at the receiver end for equalization of the DPCH channel will be explained in the following text.

If only the data components (D, DATA fields) of the DPCH channel are considered, then, for example, the decision variable z_{DATA}(k) for a RAKE receiver is governed by the weighted sums over all the path contributions:

$$\begin{matrix}{z}_{DATA} ( k ) = {\sum }_{m = 1}^{M} {W}_{DATA ; m}^{*} ( k ) {x}_{DATA ; m} ( k ) , \\ where & ( 7 ) \\ {x}_{DATA ; m} ( k ) = {\underbrace{{W}_{DATA} {a}_{D ; m} ( k ) {s}_{DATA} ( k )}}_{Signal payload component} + {\underbrace{{n}_{D ; m} ( k )}}_{Interference component} . & ( 8 )\end{matrix}$$

The path weights w_{DATA;m}(k) which are used for RAKE equalization in this case typically include an estimate of the resultant channel coefficients W_{DATA}a_{D;m}(k).

One possibility for channel estimation is to use the channel coefficient estimates based on the P-CPICH channel as estimated values for the resultant channel coefficients W_{DATA}a_{D;m}(k), m=1, . . . , M, that is to say:
W_{DATA}a_{D;m}(k)=W_{C}a_{C;m}(k)+ε_{C;m}(k). (9)
The term ε_{C;m}(k) in the above equation represents additive estimation errors, which produce additional interference influences and thus adversely affect the achievable SINR.

1. The conventional standard approach (that is to say the approach that is known from the prior art) for calculation of the path weights comprises the use of the estimated values for the resultant channel coefficients W_{DATA}a_{D;m}(k), m=1, . . . , M, as path weights.
W_{DATA;m}(k)=W_{DATA}a_{D;m}(k), (10)

2. The approach based on the MRC principle (which is likewise known from the prior art) is to use the estimated values for the resultant channel coefficients W_{DATA}a_{D;m}(k), m=1, . . . , M, weighted with the interference power on the m-th path as path weights.

If one considers the data field DATA in the DPCH channel, then, for the SINR ρ_{DATA;m} of the m-th path:

$${ρ}_{DATA ; m} = \frac{{S}_{DATA ; m}}{{N}_{D ; m}} = \frac{{W}_{DATA}^{2} {\vert {a}_{D ; m} \vert}^{2}}{{σ}_{D ; m}^{2}} ; \qquad ( 11 )$$

where
W_{DATA}=W_{DATA,Offset}W_{PC}W_{D,FS}. (12)

In this case,

$${S}_{DATA ; m} = {W}_{DATA}^{2} {\vert {a}_{D ; m} \vert}^{2}$$

denotes the data signal power on the m-th path, and N_{D;m}=σ_{D;m}² denotes the interference power on the m-th path.

The path weights for MRC are given by:

$${w}_{DATA ; m} ( k ) = \frac{{W}_{DATA} {a}_{D ; m} ( k )}{{σ}_{D ; m}^{2}} \qquad ( 13 )$$

3. A further approach is to use the estimated values for the resultant channel coefficients W_{DATA}a_{D;m}(k) multiplied by a correction factor which indicates the ratio of a gain estimate in the channel whose power is regulated to a gain estimate Ŵ_{C} based on the P-CPICH channel, as path weights. This ratio compensates for the power regulation in the channel whose power is regulated. The estimated gain value for the data field DATA that is considered by way of example here for the DPCH channel whose power is regulated (and which is considered here by way of example) is denoted by Ŵ_{DATA}.

$${w}_{DATA ; m} ( k ) = \frac{{\hat{W}}_{DATA}}{{\hat{W}}_{C}} {W}_{DATA} {a}_{D ; m} ( k ) , \qquad ( 14 )$$

The background to this approach is that, even if there were no estimation error, the known approaches 1 and 2 have a fundamental disadvantage: according to the equations (10), it is necessary for w_{DATA;m}(k)=W_{DATA}a_{D;m}(k). However, the P-CPICH-based estimate based on equation (9) results in w_{DATA;m}(k)=W_{C}a_{C;m}(k). It should be mentioned that the channel coefficients a_{C;m}(k) and a_{D;m}(k) are assumed to be identical and that the indices only express the fact that the channel coefficient results, on the one hand, from the processing of the P-CPICH channel and, on the other hand from the processing of the DPCH channel. If the equations (5) and (6) are considered, then it can be seen that the P-CPICH-specific gain W_{C}=W_{C,offset}W_{,SF} differs from the DPDCH-specific gain W_{DATA}=W_{DATA,offset}W_{PC}W_{D,SF} by the critical factor W_{PC}. In contrast to the other weighting factors W_{C,offset}, W_{DATA,offsett}, W_{D,SF}, W_{C,SF}, the factor W_{PC} is valuable since, as a power regulation weighting factor, it changes from one time slot to the next, and thus over a code word. With regard to the power regulation in the DPCH channel, to be more precise for the data fields D, DATA in the DPDCH channel, this results in weighting distortion of the combined data symbols. The ratio of W_{C} to W_{DATA} may in this case always vary within the order of magnitude of more than 10 dB within one code word due to the fading influences that are compensated for by the power regulation. Taking account of the power regulation in the DPCH channel on the basis of equation (14) means that power-normalized input data is supplied to the channel decoder (which is connected downstream from the RAKE equalizer). This improves the performance of the channel decoder, and leads to a reduction in the bit and block error rates.

4. A combination of the approach 2 (MRC principle) and the approach 3 (taking account of the power regulation in the DPCH channels) leads to:

$${w}_{DATA ; m} ( k ) = \frac{{\hat{W}}_{DATA}}{{\hat{W}}_{C}} \frac{{W}_{DATA} {a}_{D ; m} ( k )}{{σ}_{D ; m}^{2}} . \qquad ( 15 )$$

In summary, it can be stated that, in cases 1)-4), the channel coefficients calculated using the equation (9) are all multiplied by a correction factor f in order to calculate the path-specific path weights, with this correction factor f being defined by the expression:

$${f}_{b} = \frac{{\hat{W}}_{DATA}}{{\hat{W}}_{C}} \frac{1}{{\hat{σ}}_{D ; m}^{2}} \qquad ( 16 )$$

In this case, either the first product term or the second product term, or both product terms, or none of the product terms, may be activated or deactivated (that is to say set to be equal to unity).

The product terms are activated/deactivated as a function of transmitter, transmission and/or receiver characteristics, which are determined in the receiver and are assessed with regard to the activation/deactivation of the product terms. The following text describes one example of the activation/deactivation of the products terms W_{DATA}/Ŵ_{C} and 1/\hat{σ}_{D}², referred to in the following text as f components, as a function of various parameters.

A first parameter, which is used to decide if both f components should be activated, is the velocity v of the mobile telephone (mobile station). If the velocity v is greater than a limiting velocity vₜₕᵣₑₛₕ=ƒ(TTI_length) which depends on the length of the TTI interval, that is to say the code word length, then it must be assumed that the transmission characteristics will change significantly during a code word. A first Boolean variable a is defined by

$$a = \{ \begin{matrix}1 for v > {v}_{thresh} \\ 0 for v \leq {v}_{thresh}\end{matrix} \qquad ( 17 )$$

The velocity v in receivers is typically determined in conjunction with the channel estimation process and is thus a variable that is available in any case in the receiver.

The use of the f component W_{DATA}/Ŵ_{C} results in an improvement only when the power regulation mechanism is activated. A second Boolean variable b is thus defined:

$$b = \{ \begin{matrix}1 for power regulation ON \\ 0 for power regulation OFF\end{matrix} \qquad ( 18 )$$

For the use of the other f component 1/\hat{σ}_{D}², it is relevant how the noise component \hat{σ}_{D}² is composed. Depending on whether the noise in each combined data symbol is dominated by contributions from other cells (AWGN response) or by multipath interference in that particular cell (fading response), this has an influence on the activation/deactivation of the second f component 1/\hat{σ}_{D}². \hat{N}_{AWGN} denotes the estimated adjacent cell interference power, and \hat{N}_{MP} denotes the cell-internal multipath interference power. Alternative Boolean variables may be used to assess these relationships:

$${c}_{1} \{ \begin{matrix}1 for {\hat{N}}_{MP} > {\hat{N}}_{AWGN} \\ 0 for {\hat{N}}_{MP} \leq {\hat{N}}_{AWGN}\end{matrix} \\ {c}_{2} \{ \begin{matrix}1 for {SF}_{D} > {SF}_{thresh} \\ 0 for {SF}_{D} \leq {SF}_{thresh}\end{matrix} \qquad ( 19 )$$

The Boolean variable c₁ is based on estimates of the two noise power levels. The Boolean variable c₂ is based on a comparison of the spreading factor SF_{D} with a limiting spreading factor SFₜₕᵣₑₛₕ. Since there is a fundamental proportionality between the spreading factor and the ratio of N_{MP} to N_{AWGN}, the spreading factor SFₜₕᵣₑₛₕ is defined such that N_{MP}≈N_{AWGN} in this case. Simulations have shown that this condition is satisfied for SFₜₕᵣₑₛₕ=64 or SFₜₕᵣₑₛₕ=32.

c₁ or c₂ may optionally be used as a third Boolean variable c. The use of c₁ has the advantage of better accuracy while, in contrast, c₂ can be determined considerably more easily.

A fourth Boolean variable d is defined by the relationship

$$d = \{ \begin{matrix}1 for SIN R > SIN {R}_{thresh} \\ 0 for SIN R \leq SIN {R}_{thresh}\end{matrix} \qquad ( 20 )$$

This assesses whether a signal-to-noise power ratio exists which does or does not allow a sufficiently accurate estimate of the f components.

On the basis of the Boolean variables a, b, c, d defined in this way, the two f components can be activated or deactivated in accordance with the following rule:

$${\hat{W}}_{DATA} / {\hat{W}}_{C} = \{ \begin{matrix}{\hat{W}}_{DATA} / {\hat{W}}_{C} & for a \hat{} b \hat{} d = 1 \\ 1 & else\end{matrix} \\ 1 / {\hat{σ}}_{D}^{2} = \{ \begin{matrix}1 / {\hat{σ}}_{D}^{2} & for a \hat{} c \hat{} d = 1 \\ 1 & else\end{matrix} . \qquad ( 21 )$$

In this case, Λ denotes the logical AND relationship. The correction factor f can be recalculated continuously and repeatedly, thus resulting in continuous optimization of the receiver behaviour with respect to the quotient of the reception quality and the power consumption. In this case, it should be remembered that the activation and deactivation of both f components must take place at the TTI interval boundaries.

It should be mentioned that the Boolean variables (equations 17 to 20) mentioned above, as well as the activation/deactivation rule (equation 21), may have other variables added to them, or may be configured in a different form. For example, channel profile characteristics may advantageously additionally be considered as further parameters. An advantageous feature for the invention is that scenario-dependent activation and deactivation of the f components is used for calculation of the path weights from the channel coefficients as determined during the channel estimation process.

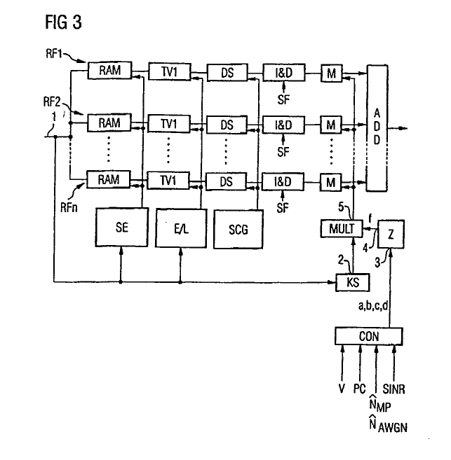

FIG. 3 shows a simplified outline illustration of a RAKE receiver with a unit according to the invention for calculation of correction factors as a function of the operating mode, for determination of path weights. The design of a RAKE receiver is known, and will be explained only cursorily in the following text. A RAKE receiver has a number of RAKE fingers RF1, RF2, . . . , RFn, which are located parallel to one another and each have a delay stage RAM, TVI, a despreading stage DS, an integrator I&D and a multiplier M. The outputs of the RAKE fingers RF1, RF2, . . . , RFn are passed to an adder ADD, which adds the signal contributions (which have been demodulated on a path-by-path basis), and in this way reconstructs the transmitted signal.

The method of operation of a RAKE receiver is as follows:

On the input side, the RAKE receiver is supplied with an overall signal that is obtained from the super-imposition of all the received signals, also including the pilot signal on the P-CPICH channel and the payload data signal on the DPCH channel. The delay unit RAM (Random Access Memory), and the TVI (Time Variant Interpolator) are used for synchronization of the RAKE fingers RF1, RF2, . . . , RFn. For this purpose, a search device SE (searcher) determines the channel profile, which indicates the time delays on each propagation path. Each of the memories RAM is driven at the search device SE end by one of the determined time delays, that is to say this ensures that a sample value read from the memory RAM is retarded by the appropriate path-specific time delay with respect to the time at which it was read. In consequence, each RAKE finger RF1, RF2, . . . , RFn is associated with a specific propagation path in the transmission channel. Sample values that are synchronized with respect to the time accuracy provided by the sampling frequency (for example twice the chip rate) are produced at the output of the memory RAM.

Fine time synchronization is carried out by means of the interpolators TVI, which readjust (retrospectively recalculate) in a known manner the sampling time as a function of the output signal from an early/late correlator E/L. Furthermore, the interpolators TVI reduce the sampling rate to the chip rate. The interpolators TVI ensure that the sample values that are present in the signal path downstream from the interpolators TVI always represent sample values at the optimum sampling time (that is to say with the maximum chip energy).

In the despreading stages DS, the arriving sample values are multiplied by the channel-specific channelization code and by the base-station-specific scrambling code. These two codes are provided by a unit SCG (Spreading Code Generation). This despreading process results in the subscriber separation and, in the case when a signal is received from a number of base stations, in the selection of one of the transmitting base stations.

The integrators I&D (Integrate&Dump) integrate the sample values (chips) over the length of one symbol. Since one symbol comprises SF chips, the SF chips are in each case added up in the integrators I&D, and are output as a symbol.

The signal vectors x_{D}(k) and x_{C}(k) are available at this point in the data transmission path in the RAKE receiver. Each vector component is produced by one of the fingers RF1, . . . , RFn. The path-specific signal contributions (vector components) produced in this way are multiplied in the multipliers M, in accordance with equation (7), by the path-specific path weights.

A channel estimator KS is used to determine the channel coefficients on the basis of a pilot channel (for example P-CPICH). The estimated channel coefficients W_{C}a_{C;m}(k) on the basis of equation (9) are produced at the output 2 of the channel estimator. These are multiplied by the correction factor f in a multiplier MULT.

A control unit CON and an association unit Z are used to determine the correction factor f. The control unit CON receives the parameters v, PC (power regulation ON/OFF), \hat{N}_{MP}, \hat{N}_{AWGN}, SINR. The controller CON calculates the Boolean variables a, b, c, d in accordance with the equations (17) to (20). The association unit Z calculates the correction factor f by selectively activating/deactivating the f components as a function of the Boolean variables a, b, c, d in accordance with equation (21). The correction factor f determined in this way is produced at an output 4 of the association unit Z. The channel coefficients multiplied by the variable correction factor f are emitted as path weights at an output 5 of the multiplier MULT.

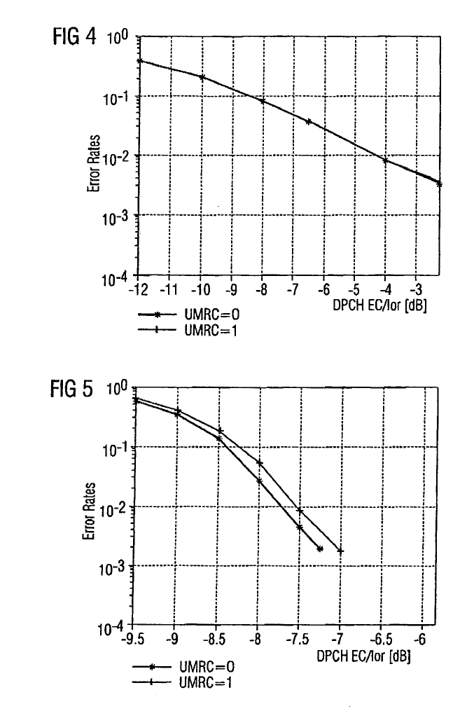

FIG. 4 shows the block error rate for an actual receiver compared to the ratio of the mean transmission energy in each chip on the DPCH channel to the spectral density of the overall transmission power Ec/Ior, shown in dB, for a first transmission scenario with the f component 1/\hat{σ}_{D}² activated (UMRC=0) and deactivated (UMRC=1). The first transmission scenario is based on a fading response of the mobile radio channel (\hat{N}_{AWGN}<\hat{N}_{MP}) and a transmission rate of 384 kbps. This is based on a multipath channel with two paths whose signal attenuations are 0 dB and −10 dB. The mobile station is travelling at low velocity (3 km/h), and the transmission is based on a high spreading factor (SF_{D}=128) in the payload data channel DPCH. FIG. 4 shows that the low velocity and the high spreading factor mean that the activation of the f component 1/\hat{σ}_{D}² does not result in any significant improvement. It is therefore not activated.

The illustration in FIG. 5 is based on a transmission scenario in which the mobile station is travelling at a high velocity (120 km/h) with a fading response in the transmission channel and using a transmission rate of 384 kbps. A lower spreading factor (SF_{D}=32) is used, and a multipath channel is considered, with four propagation paths whose signal attenuations are: 0 dB, −4 dB, −6 dB, −9 dB. As can be seen, the use of the f component 1/\hat{σ}_{D} ² is advantageous in this case, since the spreading factor is low and the velocity is high. Activation of the f component 1/\hat{σ}_{D}² results in an improvement of about 0.3 dB.

The calculation of the noise variance \hat{σ}_{D}² for the MRC is known from the prior art, and will therefore not be explained in any more detail in the following text.

The calculation of the gain estimation ratio Ŵ_{DATA}/Ŵ_{C} will be explained in more detail in the following text based on an example.

On the one hand, the equation:

$$\overline{{\vert {X}_{DATA , m} \vert}^{2}} = \frac{1}{{K}_{DATA}} {\sum }_{k = 1}^{{K}_{DATA}} {\vert {X}_{DATA ; m} ( k ) \vert}^{2} \qquad ( 22 )$$

results in path-specific signal averaging over the total number K_{DATA} of data symbols in the DATA field in the DPCH channel. The signal power S_{DATA}(z) is then calculated for the mobile radio cell z on the basis of the averaged path-specific signal power levels. This is done by addition over all of the M(z) propagation paths for the mobile radio cell z under consideration, using the equation:

$${S}_{DATA} ( z ) = {\sum }_{m = 1}^{M ( z )} \overline{{\vert {X}_{DATA , m} \vert}^{2}} - M ( z ) {N}_{D} ( z ) \qquad ( 23 )$$

In this case, N_{D}(z) denotes the noise power in the DPCH channel, averaged over all of the propagation paths for the cell z. This is determined in the known manner in the course of calculation of the noise variance \hat{σ}_{D}² for MRC.

On the other hand, the power in the P-CPICH channel is calculated using the equations:

$${\overline{y}}_{C ; m} = \frac{1}{{K}_{C}} {\sum }_{k = 1}^{{K}_{C}} {W}_{C} {\hat{a}}_{C ; m} ( k ) \\ {S}_{c} ( z ) = {\sum }_{m = 1}^{M ( z )} {\vert {\hat{y}}_{C ; m} \vert}^{2} . \qquad ( 24 )$$

In this case, the (channel-filtered) pilot symbols in the P-CPICH channel are used as input variables, with W_{C}â_{C;m}(k).

Finally, the ratio Ŵ_{DATA}/Ŵ_{C} for the cell z is calculated using the equation:

$$( \frac{{\hat{W}}_{DATA}}{{\hat{W}}_{C}} ) ( z ) = \sqrt{\frac{{S}_{DATA} ( z )}{{S}_{c} ( z )}} \qquad ( 25 )$$

from the signal power value S_{DATA}(z) for the DATA field in the DPCH channel, and the signal power level S_{C}(z) for the P-CPICH channel.

Although the invention has been illustrated and described with respect to one or more implementations, alterations and/or modifications may be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method for variable weighting of channel coefficients for a RAKE receiver, comprising:
(a) estimating channel coefficients for a number of propagation paths of a transmission channel;
(b) assessing at least one variable that is characteristic of a transmitter or transmission channel or receiver characteristic;
(c) determining a correction factor (f) as a function of the assessment for at least one channel coefficient; and
(d) multiplying the channel coefficient by the determined correction factor (f), with an equalization in the RAKE receiver being based on the channel coefficient multiplied by the correction factor.

2. The method according to claim 1, further comprising repeating acts (b) and (c) continuously during reception.

3. The method according to claim 1, wherein determining the correction factor comprises assigning either a predetermined fixed value or at least one of the following values, as a function of the assessment: the ratio of a transmission-channel-specific gain estimate to a pilot-channel-based gain estimate, an estimated value for the noise variance of one propagation path of the transmission channel, the product of the ratio of a transmission-channel-specific gain estimate to a pilot-channel-based gain estimate, and an estimated value for the noise variance of one propagation path of the transmission channel.

4. The method according to claim 3, wherein the correction factor (f) is assigned any one of the four values based on the assessment.

5. The method according to claim 1, wherein determining the correction factor comprises:
determining that the correction factor f comprises f=1 for a first assessment result;
determining that the correction factor f comprises
$$f = \frac{{\hat{W}}_{DATA}}{{\hat{W}}_{C}}$$
for a second assessment result, where Ŵ_{DATA} is an estimated value of the transmitter-end gain of the transmission channel whose power is regulated, and Ŵ_{C} is an estimated value of the transmitter-end gain of a common pilot channel;
determining that the correction factor f comprises
$$f = \frac{1}{{\hat{σ}}_{D}^{2}}$$
for a third assessment result, where \hat{σ}_{D} is an estimated value for the noise variance of the transmission channel whose power is regulated; and
determining that the correction factor f comprises
$$f = \frac{{\hat{W}}_{DATA}}{{\hat{W}}_{C}} \frac{1}{{\hat{σ}}_{D}^{2}}$$
for a fourth assessment result.

6. The method according to claim 1, wherein assessing at least one variable comprises assessing a speed of the RAKE receiver relative to the transmitter.

7. The method according to claim 1, wherein assessing at least one variable comprises assessing whether the power of the transmission channel is being regulated in the transmitter.

8. The method according to claim 1, wherein assessing at least one variable comprises assessing whether a AWGN noise component, which is caused by adjacent cell interference, or a fading noise component, which is caused by intercell multipath interference, is dominant.

9. The method according to claim 1, wherei assessing at least one variable comprises assessing a SINR ratio of the signal that is transmitted via the transmission channel.

10. The method according to claim 1, further comprising changing the correction factor (f) as a consequence of a change in the assessment at interval boundaries of code words of the payload data that is transmitted via the transmission channel.

11. An apparatus for variable weighting of channel coefficients for a RAKE receiver as a function of a number of operating modes, comprising:
means for estimating channel coefficients for a number of propagation paths of a transmission channel;
means for assessing at least one variable that is characteristic of a transmitter or transmission channel or receiver characteristic;
means for determining a correction factor (f) as a function of the assessment result for at least one channel coefficient; and
means for multiplying the channel coefficient by the determined correction factor (f), with an equalization in the RAKE receiver being based on the channel coefficient multiplied by the correction factor (f).

12. The apparatus according to claim 11, the correction factor (f) comprises a predetermined fixed value or at least one of the following values, as a function of the assessment result: a ratio of a transmission-channel-specific gain estimate to a pilot-channel-based gain estimate, an estimated value for the noise variance of one propagation path of the transmission channel, and a product of the ratio of a transmission-channel-specific gain estimate to a pilot-channel-based gain estimate, and an estimated value for the noise variance of one propagation path of the transmission channel.

13. The apparatus according to claim 11, wherein the correction factor f comprises f=1 for a first assessment result, the correction factor f comprises f=
$$\frac{{\hat{W}}_{DATA}}{{\hat{W}}_{C}}$$
for a second assessment result, where Ŵ_{DATA} is an estimated value of the transmitter-end gain of the transmission channel whose power is regulated, and Ŵ_{C} is an estimated value of the transmitter-end gain of a common pilot channel, the correction factor f comprises f=
$$\frac{1}{{\hat{σ}}_{D}^{2}}$$
for a third assessment result, where \hat{σ}_{D} is an estimated value for the noise variance of the transmission channel whose power is regulated, and the correction factor f comprises f=
$$\frac{{\hat{W}}_{DATA}}{{\hat{W}}_{C}} \frac{1}{{\hat{σ}}_{D}^{2}}$$
for a fourth assessment result.

14. The apparatus according to claim 11, wherein the assessment means assesses a speed of the RAKE receiver relative to the transmitter as the characteristic variable.

15. The apparatus according to claim 11, wherein the assessment means assesses whether the power of the transmission channel is being regulated in the transmitter as the characteristic variable.

16. The apparatus according to claim 11, wherein the assessment means assesses whether an AWGN noise component, which is caused by adjacent channel interference, or a fading noise component, which is caused by intercell multipath interference, is dominant as the characteristic variable.

17. The apparatus according to claim 11, wherein the assessment means assesses an SINR ratio as the characteristic variable.

18. A method for variable weighting of channel coefficients for a RAKE receiver, comprising:
(a) estimating channel coefficients for a number of propagation paths of a transmission channel;
(b) assessing at least one variable that is characteristic of a transmitter or transmission channel or receiver characteristic;
(c) determining a correction factor (f) as a function of the assessment for at least one channel coefficient; and
(d) adjusting the channel coefficient based on the determined correction factor (f), with an equalization in the RAKE receiver being based on the adjusted channel coefficient.

19. The method according to claim 18, wherein determining the correction factor comprises assigning either a predetermined fixed value or at least one of the following values, as a function of the assessment: the ratio of a transmission-channel-specific gain estimate to a pilot-channel-based gain estimate, an estimated value for the noise variance of one propagation path of the transmission channel, the product of the ratio of a transmission-channel-specific gain estimate to a pilot-channel-based gain estimate, and an estimated value for the noise variance of one propagation path of the transmission channel.
